(19) United States
(12) Patent Application Publication
(10) Pub. No.: US 2024/0301673 A1
(43) Pub. Date: Sep. 12, 2024

(54) A DRAINAGE DEVICE

(71) Applicant: Nicolaas Johannes VAN DER MERWE, Waltloo, Pretoria (ZA)

(72) Inventor: Andre Louis VAN NIEKERK, Pretoria (ZA)

(21) Appl. No.: 18/044,239

(22) PCT Filed: Sep. 6, 2021
(86) PCT No.: PCT/ZA2021/050050

§ 371 Date: Mar. 7, 2023

(30) Foreign Application Priority Data
Sep. 7, 2020 (ZA) 2020/05523

(51) Int. Cl. E03C 1/24; B29D 23/00

(52) U.S. Cl. CPC E03C 1/24; B29D 23/00; B29K 2827/06; B29K 2855/02; B29K 2995/0094; B29K 2995/0097

(57) ABSTRACT

According to the invention, there is provided a drainage device (10) including a body (14) defining a passage (16) having opposing end regions (18) which extend between and interconnect overflow and drainage apertures (20) and (22) defined in the receptacle (12) to permit fluid flow therebetween, typically from the overflow aperture (20) via the drainage aperture or plug hole (22) to a drain (not shown).

### TECHNICAL FIELD

This invention relates to a drainage device for sanitaryware. More particularly, the invention relates to a drainage device for permitting drainage of overflow fluid in a sanitaryware such as a bath or basin.

### SUMMARY OF THE INVENTION

According to a first aspect of the invention, there is provided a drainage device including:—
a body defining a passage having opposing end regions which extend between and interconnect overflow and drainage apertures defined in a receptacle to permit fluid flow therebetween.

It is to be appreciated that the body may permit fluid flow from the overflow aperture via the drainage aperture and/or plug hole to a drain.

The body may be in the form of an elongate tubular member, typically having openings defined at opposing end regions thereof. The body may be shaped, preferably being bent, to conform to a side wall and/or a portion of a base of the receptacle. The body may be sized to be received within the side wall and/or the portion of the base. In particular, the body may have a thickness smaller than that of the side wall and/or base of the receptacle. The body may be located substantially centrally relative opposing inner and outer surfaces of the side wall, preferably wherein the body is substantially surrounded by the side wall in a moulded condition. Alternatively, the body may be received by a receiving formation defined in an outer surface of the side wall. The receiving formation may be sized and/or shaped to receive the body complementally therein such that outer surfaces of the body and the side wall are flush with each other in a receiving condition. The body may have a thickness in the range of 3 mm to 20 mm, the thickness of the body typically being dependent on the thickness of the wall of the receptacle, the body preferably having a thickness in the region of 7 mm for receptacles having approximately 20 mm thick walls. A cross-sectional shape of the body may be of any suitable geometric shape of the group including parallelepiped, polygonal, circular, ovular, elliptical, square, rectangular, and triangular, preferably being generally rectangular. The body may have a width in the region of 25 mm to 150 mm, preferably being in the region of 61 mm. Walls of the body may have a thickness in the range of 0.4 mm to 2 mm, preferably being in the region of 1 mm. The body may be manufactured from any suitable synthetics, plastics or metallic material, preferably being manufactured from a plastics material such as PVC (polyvinylchloride) or ABS (acrylonitrile butadiene styrene). Further preferably, the body may be manufactured from rigid PVC.

The openings to the passage of the body may be sized to ensure substantially unencumbered fluid flow through the body. Preferably, the openings to the passage may be sized to permit a flow rate of fluid therethrough which is similar to that of a pipe having a diameter in the range of 5 mm to 50 mm, preferably being similar to that of a pipe having a diameter in the region of 10 mm. The openings may have a length and width in the ranges of 40 mm to 160 mm and 2 mm to 20 mm, respectively, preferably having a length and width in region of 59 mm and 4 mm, respectively.

The receptacle may be in the form of a sanitaryware receptacle. The sanitaryware receptacle may be in the form of any receptacle of the group including a bath, basin, and cistern.

Strengthening means, preferably in the form of a rib formation, may be provided for strengthening the body during bending thereof, typically during a manufacturing or production process thereof. In particular, the rib formation may be located within and extend along a length of the body. More particularly, a plurality of rib formations, preferably a pair, may be spaced apart along a width of the body for uniformly strengthening the body along its width in order to ensure that the passage remains open during bending of the body.

A mounting arrangement may be provided for mounting the body to an inner wall of a mould for the receptacle. The mounting arrangement may include a mounting member including an extension which may be sized, shaped and/or configured to engage, preferably via interference fit engagement, with a receiving means, preferably in the form of an aperture, defined in the inner wall of the mould. More particularly, the extension may be sized, shaped and/or configured such that during a mounted condition, the body is positioned substantially centrally relative opposing inner surfaces of the mould and/or relative opposing outer surfaces of the moulded receptacle. The extension may have a length in the range of 4 mm to 15 mm, preferably being in the region of 6 mm to 7 mm. The extension may be of any suitable geometric shape in cross-section, preferably being generally cylindrical in shape and/or having a generally circular cross-section. Preferably, the mounting member may include a pair of extensions for improving the interference fit with the receiving means of the mould. The receiving aperture may be sized and/or shaped to receive the extension complementally therein so as to permit interference fit engagement therebetween. The receiving means may be in the form of a pair of apertures, typically corresponding to the pair of extensions of the mounting member.

The mounting member may include a connecting formation for connecting the extensions to the body. In particular, the connecting formation may be sized, shaped and/or configured to engage, preferably complementally, with an end region of the body. More particularly, the connecting formation may be sized and/or shaped to be received complementally by the opening in the body.

A pair of mounting members may be provided for mounting the body, via its opposing end regions, to the inner wall of the mould for ensuring secure mounting of the body on the mould and for inhibiting displacement of the body when moulding material is pumped into the mould.

Closure members may be provided for closing openings to the passage on opposing end regions of the body during moulding of the receptacle. The closure members may be in the form of the connecting formation of the mounting member. It is to be appreciated that the closure members serve to inhibit the ingress of pre-moulded moulding material into the passage of the body during pumping thereof into the mould for the receptacle.

Inhibiting formations may be provided for inhibiting displacement of the extensions into the receiving means beyond a predetermined distance thereby ensuring that the body is substantially centrally positioned relative opposing inner surfaces of the mould and/or relative opposing outer surfaces of the moulded receptacle before moulding of the receptacle. The inhibiting formations may be located towards a base region of the extension and may be sized to inhibit entry thereof into the receiving means. The inhibiting formation may be located a distance from an end region of the extension in the range of 4 mm to 8 mm, preferably being in the region of 6 mm to 7 mm.

Locating means may be provided for locating opposing end regions of the body after moulding of the receptacle. The locating means may be in the form of a protruding member, preferably a pair of protruding members, which may be mounted on and/or extend from the opposing end regions of the body. The protruding members may have a length for allowing free end regions thereof to protrude from the moulded receptacle thereby indicating to a worker a location of the opposing end regions of the body. The protruding members may be formed integrally with the extensions of the mounting members, the protruding members typically being the extensions of the mounting members.

The locating means, mounting members, connecting formations and closure members may be formed integrally with each other. More specifically, the locating means, mounting members, connecting formations and closure members form part of the same body or object.

According to a second aspect of the invention, there is provided a receptacle including:—a base;
a wall extending from a periphery of the base to define a receiving zone for receiving fluid therein;
a drainage aperture defined in the base for allowing drainage of fluid from the receiving zone;
an overflow aperture defined in the wall for allowing excess fluid to drain from the receiving zone; and
a drainage device as hereinbefore described which extends between and interconnects the overflow and drainage apertures to permit fluid flow from the overflow aperture via the drainage aperture and/or plug hole to a drain.

The receptacle may be in the form of a sanitaryware receptacle. The sanitaryware receptacle may be in the form of any receptacle of the group including a bath, basin, and cistern.

According to a third aspect of the invention, there is provided a method for moulding a sanitaryware receptacle which includes:—mounting a drainage device as hereinbefore described to an inner surface of a mould for a sanitaryware receptacle, the drainage device being positioned relative the mould such that the end regions of the drainage device coincide with locations of overflow and drainage apertures to be made in the receptacle once moulded;
pumping moulding material into the mould thereby substantially surrounding the drainage device with moulding material;
allowing the moulding material to harden to form the receptacle;
removing the mould from the moulded receptacle;
locating end regions of the drainage device via its protruding members which typically protrude from the receptacle at the locations where the overflow and drainage apertures are to be made;
making a drainage aperture through a base portion of the sanitaryware receptacle, the drainage aperture extending through the base portion and a portion of a first end region of the drainage device; and
making an overflow aperture in the side wall of the receptacle and through a second end region of the drainage device and in doing so, opening a drainage passage defined by the drainage member which extends between the overflow and drainage apertures of the receptacle.

Mounting the drainage device to the mould may include inserting the extensions of mounting members located at opposing end regions of the drainage device into corresponding receiving apertures defined in the mould.

The drainage aperture may be of generally circular shape. Making of the drainage aperture may be carried out with the use of a drill, typically having a hole-saw-type bit fastened thereto.

The overflow aperture may be of any suitable geometric shape, preferably being generally elongate. It is to be appreciated that the overflow aperture may be shaped according to the design of the receptacle. The overflow aperture may be in the form of an elongate slot. Making of the overflow aperture may be carried out with the use of a drill or router, typically having a conventional drill bit fastened thereto. Preferably, drilling of the elongate slot may be carried out with the aid of a router also known as routering.

### BRIEF DESCRIPTION OF THE DRAWINGS

A drainage device, sanitaryware and a method of moulding sanitaryware in accordance with the invention will now be described by way of the following, non-limiting examples with reference to the accompanying drawings.

In the drawings:—

FIG. 1 is a three-dimensional schematic showing a drainage device in accordance with the invention;

FIG. 2 is a three-dimensional schematic showing an exploded view of the drainage device shown in FIG. 1;

FIG. 3 is a cross-sectional view of the drainage device;

FIG. 4 is a sectioned side view of the drainage device mounted on a mould for a receptacle;

FIG. 5 is a sectioned side view of the drainage device in a moulded receptacle;

FIGS. 6 and 7 are enlarged sectioned side views showing an upper portion of the drainage device shown in FIGS. 4 and 5, respectively; and

FIGS. 8 and 9 are enlarged sectioned side views showing a lower portion of the drainage device shown in FIGS. 4 and 5, respectively

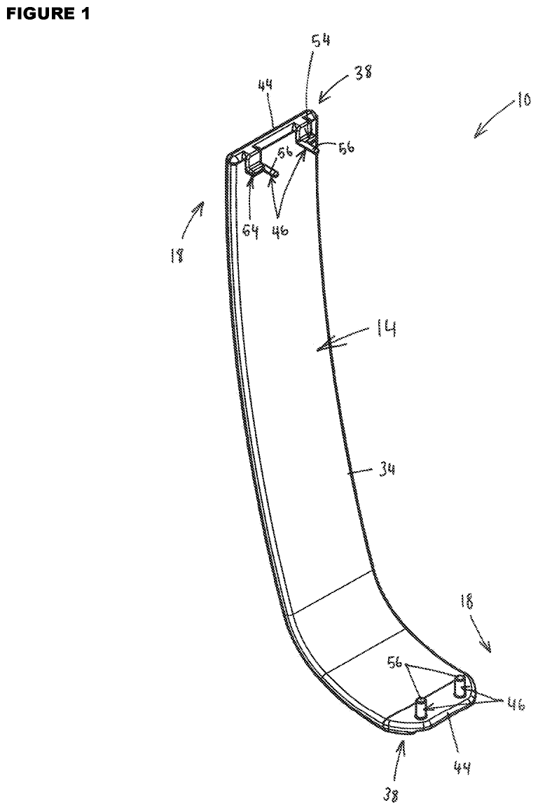

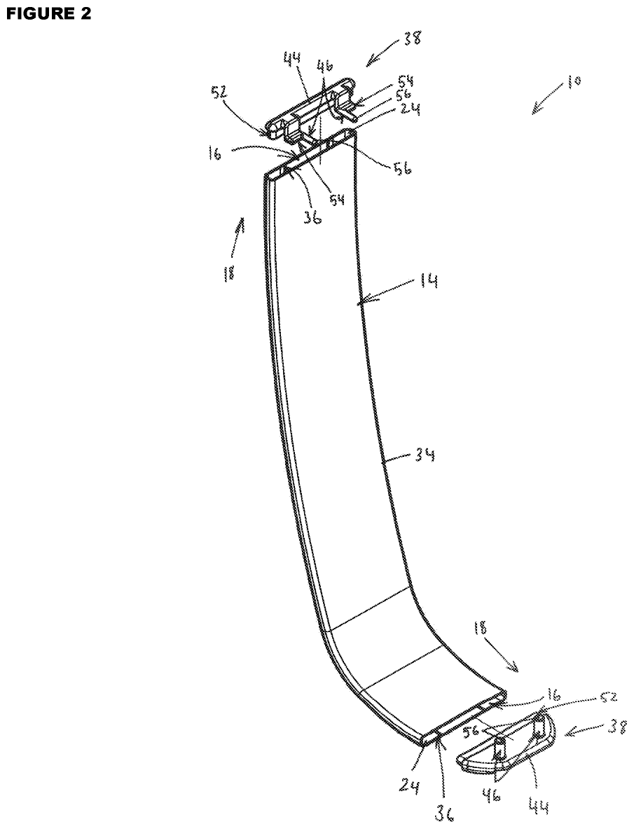

### DETAILED DESCRIPTION OF THE INVENTION

Referring now to the Figures, reference numeral 10 refers generally to a drainage device for a receptacle 12.

The drainage device 10 includes a body 14 defining a passage 16 having opposing end regions 18 which extend between and interconnect overflow and drainage apertures 20 and 22 defined in the receptacle 12 to permit fluid flow therebetween, typically from the overflow aperture 20 via the drainage aperture or plug hole 22 to a drain (not shown).

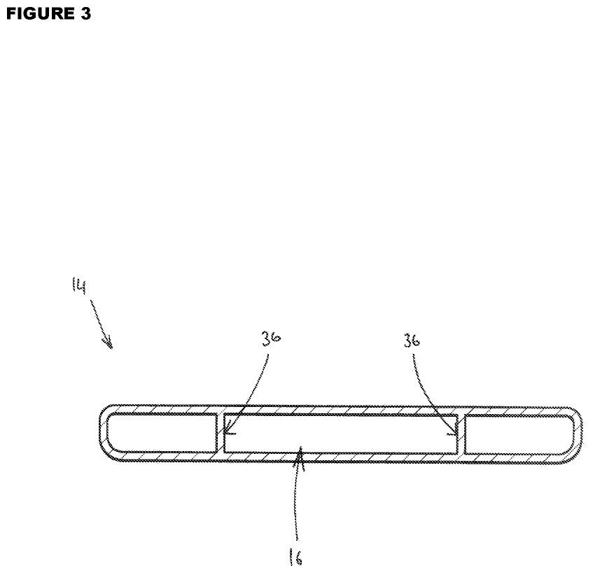

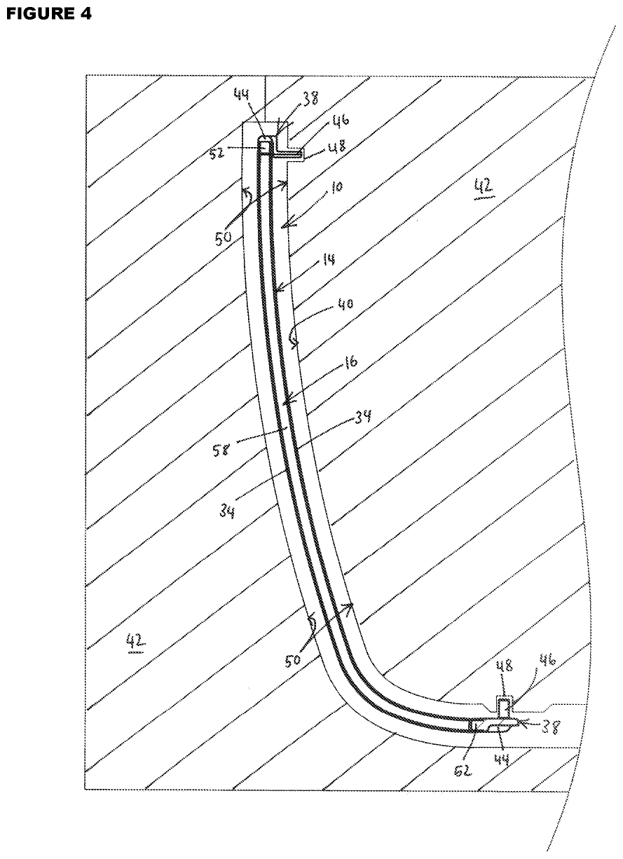

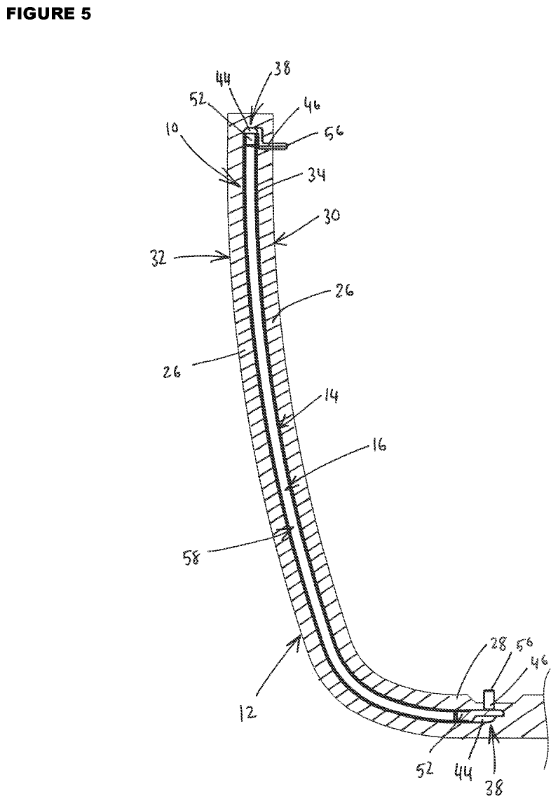

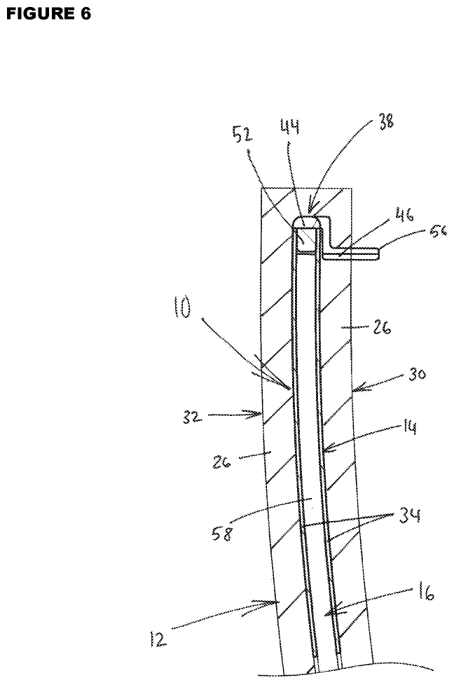

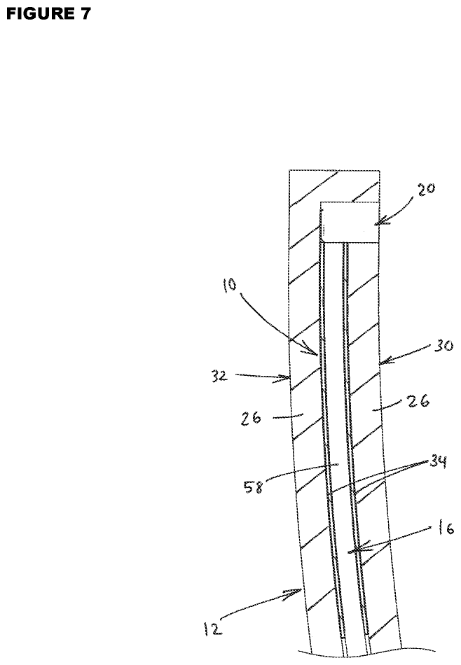

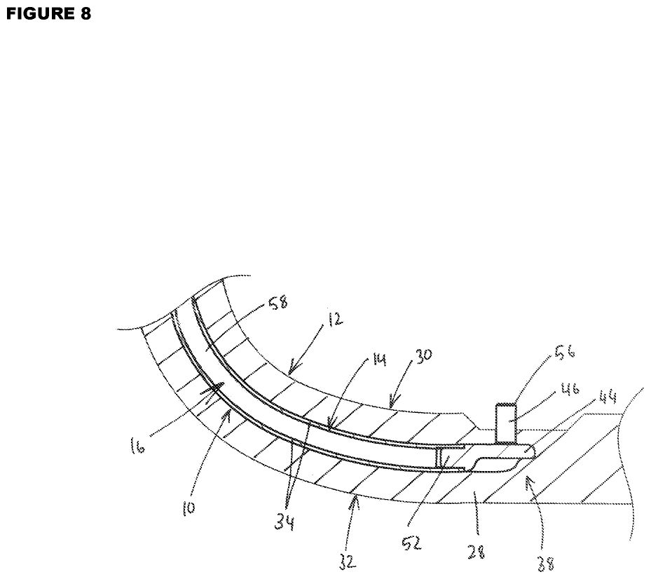

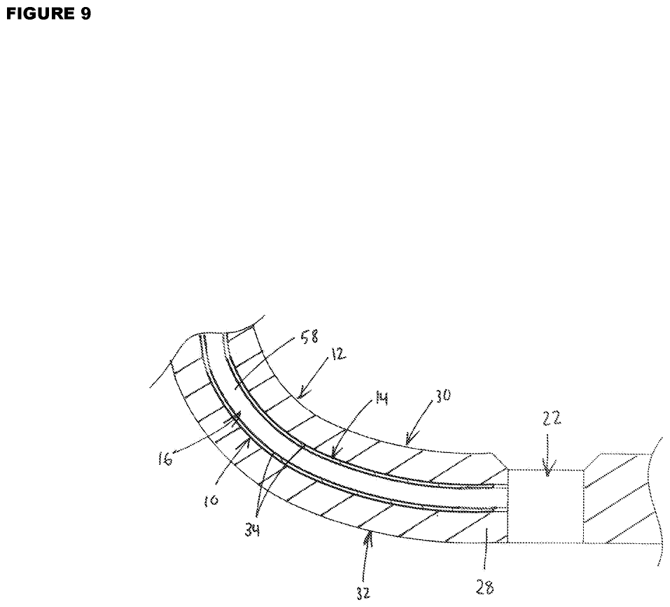

The body 14 is in the form of an elongate tubular member, typically having openings 24 defined at opposing end regions 18 thereof. The body 14 is shaped, typically being bent, to conform to a side wall 26 and/or a portion of a base 28 of the receptacle 12. The body 14 is sized to be received within the side wall 26 and/or the portion of the base 28. In particular, the body 14 has a thickness smaller than that of the side wall 26 and the base 28 of the receptacle 12. The body 14 is located substantially centrally relative opposing inner and outer surfaces 30 and 32 of the side wall 26 wherein the body 14 is substantially surrounded by the side wall 26 in a moulded condition. Alternatively, and although not shown, the body 14 can be received by a receiving formation (not shown) defined in an outer surface 32 of the side wall 26. The receiving formation (not shown) is sized and shaped to receive the body 14 complementally therein such that outer surfaces of the body 14 and the side wall 26 are flush with each other in a receiving condition. It is to be appreciated that the thickness and placement of the body 14 relative the side wall 26 and base 28 of the receptacle 12 is such that losses in structural integrity of the receptacle 12 are minimised. The body 14 has a thickness in the range of 3 mm to 20 mm, the thickness of the body typically being dependent on the thickness of the wall of the receptacle 12, the body 14 having a thickness in the region of 7 mm for receptacles having approximately 20 mm thick walls. A cross-sectional shape of the body 14 is of any suitable geometric shape of the group including parallelepiped, polygonal, circular, ovular, elliptical, square, rectangular, and triangular, typically being generally rectangular as shown most clearly in FIG. 3. The body 14 has a width in the region of 45 mm to 90 mm, typically being in the region of 61 mm. Walls 34 of the body 14 have a thickness in the range of 0.4 mm to 2 mm, typically being in the region of 1 mm. The body 14 is manufactured from any suitable synthetics, plastics or metallic material, typically being manufactured from rigid PVC (polyvinylchloride).

The openings 24 to the passage 16 of the body 14 are sized to ensure substantially unencumbered fluid flow through the body 14. Typically, the openings 24 to the passage 16 are sized to permit a flow rate of fluid therethrough which is similar to that of a pipe having a diameter in the range of 5 mm to 50 mm, typically being similar to that of a pipe having a diameter in the region of 10 mm. The openings 24 have a length and width in the ranges of 40 mm to 160 mm and 2 mm to 20 mm, respectively, typically having a length and width in region of 59 mm and 4 mm, respectively. It is to be appreciated that although specific dimensions are provided, the dimensions of the openings 24 are dependent on the dimensions of the receptacle 12 to be moulded.

The receptacle 12 is in the form of a sanitaryware receptacle. The sanitaryware receptacle is in the form of any receptacle of the group including a bath, basin, and cistern.

Strengthening means in the form of a rib formation 36 is provided for strengthening the body 14 during bending thereof, typically during a manufacturing or production process thereof. In particular, the rib formation 36 is located within and extends along a length of the body 14. More particularly, a plurality of rib formations 36, typically a pair, are spaced apart along a width of the body 14 for uniformly strengthening the body 14 along its width in order to ensure that the passage 16 remains open during bending of the body 14.

A mounting arrangement 38 is provided for mounting the body 14 to an inner wall 40 of a mould 42 for the receptacle 12. The mounting arrangement 38 includes a mounting member 44 including a pair of extensions 46 which are sized, shaped and configured to engage, typically via interference fit engagement, with a receiving means in the form of apertures 48 defined in the inner wall 40 of the mould 42. More particularly, the extensions 46 are sized, shaped and configured such that during a mounted condition, the body 14 is positioned substantially centrally relative opposing inner surfaces 50 of the mould 42 or relative opposing outer surfaces 32 of the moulded receptacle 12. It is to be appreciated that the substantially centrally located body 14 serves to minimise loss of structural integrity of the receptacle 12 to be moulded as a result of a cavity or passage 16 being formed therein. The extensions 46 have a length in the range of 4 mm to 15 mm, typically being in the region of 6 mm to 7 mm, the length being dependent on the degree of shrinkage during manufacturing. The extensions 46 are of any suitable geometric shape in cross-section, typically being generally cylindrical in shape and having a generally circular cross-section. The receiving apertures 48 are sized and shaped to receive the extensions 46 complementally therein so as to permit interference fit engagement therebetween.

The mounting member 44 includes a connecting formation 52 for connecting the extensions 46 to the body 14. In particular, the connecting formation 52 is sized, shaped and configured to engage, typically complementally, with an end region 18 of the body 14. More particularly, the connecting formation 52 is sized and shaped to be received complementally by the opening 24 in the body 14.

A pair of mounting members 44 are provided for mounting the body 14, via its opposing end regions 18, to the inner wall 40 of the mould 42 for ensuring secure mounting of the body 14 on the mould 42 and for inhibiting displacement of the body 14 when moulding material is pumped into the mould 42.

Closure members, typically taking the form of the connecting formations 42 of the mounting arrangements 38, are provided for closing openings 24 to the passage 16 on opposing end regions 18 of the body 14 during moulding of the receptacle 12. It is to be appreciated that the closure members serve to inhibit the ingress of pre-moulded moulding material into the passage 16 of the body 14 during pumping thereof into the mould 42 for the receptacle 12.

Inhibiting formations 54 are provided for inhibiting displacement of the extensions 46 into the receiving apertures 48 beyond a predetermined distance thereby ensuring that the body 14 is substantially centrally positioned relative opposing inner surfaces 50 of the mould 42 and relative opposing outer surfaces 32 of the moulded receptacle 12 before moulding of the receptacle 12. The inhibiting formations 54 are located towards a base region of the extension 46 and are sized to inhibit entry thereof into the receiving apertures 48. In use, a worker would press the extensions 46 into the receiving apertures 48 until the inhibiting formation 54 abuts an edge of the aperture 48 and thereby inhibits further displacement of the extensions 46 into the receiving aperture 48, at which point, the worker would be aware that the body 14 will be positioned correctly relative the mould 42. The inhibiting formation 54 is located a distance from an end region of the extension 46 in the range of 4 mm to 8 mm, typically being in the region of 6 mm to 7 mm.

It is to be appreciated that once the receptacle 12 has been moulded, the overflow and drainage apertures 20 and 22 are required to be made, typically by drilling into the receptacle 12 at predetermined locations. The overflow aperture 20 is typically located in an inner surface 30 of the receptacle 12 at a maximum desired fluid height and the drainage aperture 22 is typically located in the base portion 28 of the receptacle 12, typically the lowest part thereof for ensuring that the most fluid possible is drained therefrom in use.

Locating means in the form of protruding members 56 are provided for locating opposing end regions 18 of the body 14 after moulding of the receptacle 12. It is to be appreciated that the locating means serves to allow a worker to drill out overflow and drainage apertures 20 and 22 at locations which coincide with the end regions 18 of the body 14 thereby opening the passage 16 and defining an overflow passage 58 in the wall 26 and base 28 of the receptacle 12, which passage 58 extends from the overflow aperture 20 to the drainage aperture 22 of the receptacle 12. The protruding members 56 are mounted on or extend from the opposing end regions 18 of the body 14. The protruding members 56 have a length for allowing free end regions thereof to protrude from the moulded receptacle 12 thereby indicating to a worker a location of the opposing end regions of the body 14. The protruding members are formed integrally with the extensions 46 of the mounting members 44, the protruding members 56 typically being the extensions 46 of the mounting members 44.

As shown in the Figures, the protruding members 56, mounting members 44 and connecting formations 52 are formed integrally with each other.

In accordance with a second aspect of the present invention, there is provided a receptacle 12 including a base 28, a wall 26 extending from a periphery of the base 28 to define a receiving zone (not shown) for receiving fluid therein, a drainage aperture 22 defined in the base 28 for allowing drainage of fluid from the receiving zone (not shown), an overflow aperture 20 defined in the wall 26 for allowing excess fluid to drain from the receiving zone (not shown) and a drainage device 10 as hereinbefore described which extends between and interconnects the overflow and drainage apertures 20 and 22 to permit fluid flow from the overflow aperture 20 via the drainage aperture or plug hole 22 to a drain (not shown).

The receptacle 12 is in the form of a sanitaryware receptacle. The sanitaryware receptacle is in the form of any receptacle of the group including a bath, basin, and cistern.

In accordance with a third aspect of the invention, there is provided a method for moulding a sanitaryware receptacle 12 which includes mounting a drainage device 10 as hereinbefore described to an inner surface 50 of a mould 42 for a sanitaryware receptacle 12, the drainage device 10 being positioned relative the mould 42 such that the end regions 18 of the drainage device 10 coincide with locations of overflow and drainage apertures 20 and 22 to be made in the receptacle 12 once moulded, pumping moulding material (not shown) into the mould 42 thereby substantially surrounding the drainage device 10 with moulding material, allowing the moulding material to harden to form the receptacle 12, removing the mould 42 from the moulded receptacle 12, locating end regions 18 of the drainage device 10 via its protruding members 56 which typically protrude from the receptacle 12 at the locations where the overflow and drainage apertures 20 and 22 are to be made, making a drainage aperture 22 through a base portion 28 of the receptacle 12, the drainage aperture 22 extending through the base portion 28 and a portion of a first end region 18 of the drainage device 10, and making an overflow aperture 20 in the side wall 26 of the receptacle and through a second end region 18 of the drainage device 10 and in doing so, opening a drainage passage 56 defined by the drainage member 10 which extends between the overflow and drainage apertures 20 and 22 of the receptacle 12.

Mounting the drainage device 10 to the mould includes inserting the extensions 46 of mounting members 44 located at opposing end regions 18 of the drainage device into corresponding receiving apertures 48 defined in the mould 42.

The drainage aperture 22 is of generally circular shape. Making of the drainage aperture 22 is carried out with the use of a drill, typically having a hole-saw-type bit fastened thereto.

The overflow aperture 20 is of any suitable geometric shape, typically being generally elongate. The overflow aperture 20 is in the form of an elongate slot. Making of the overflow aperture 20 is carried out with the use of a drill, typically having a conventional drill bit fastened thereto. Typically, drilling of the elongate slot is carried out with the aid of a router.

It is, of course, to be appreciated that the drainage device in accordance with the invention is not limited to the precise constructional and functional details as hereinbefore described with reference to the accompanying drawings and which may be varied as desired.

Although only certain embodiments of the invention have been described herein, it will be understood by any person skilled in the art that other modifications, variations, and possibilities of the invention are possible. Such modifications, variations and possibilities are therefore to be considered as falling within the spirit and scope of the invention and hence form part of the invention as herein described and/or exemplified. It is further to be understood that the examples are provided for illustrating the invention further and to assist a person skilled in the art with understanding the invention and is not meant to be construed as unduly limiting the reasonable scope of the invention.

The inventor believes that the drainage device in accordance with the present invention is advantageous in that it allows a drainage passage to be formed within a wall of sanitaryware, in order to remove unappealing piping from outside the sanitaryware extending from the overflow aperture to the drainage pipe below the sanitaryware. Further, due to the material of the drainage device and the manner in which it is mounted on the mould, pumping the mould material into the mould does not compromise the structure or position of the drainage device thereby minimising losses in structural integrity of the moulded sanitaryware. Further, use of the drainage device in accordance with the present invention during moulding of sanitaryware reduces the likelihood of failure thereof after moulding due to varying wall thickness of the sanitaryware. The inventor believes it to be a further advantage in that the space between the base of a bath and the floor, and hence the height of the bath, could be reduced so as to facilitate getting in and out of the bath.

1. A drainage device including:—
a body defining a passage having opposing end regions which extend between and interconnect overflow and drainage apertures defined in a receptacle to permit fluid flow therebetween; and
strengthening means for the body bending thereof.

2-8. (canceled)

9. A drainage device as claimed in claim 1, wherein the body is located substantially centrally relative opposing inner and outer surfaces of a side wall of a receptacle for the body.

10. A drainage device as claimed in claim 1, wherein the body is received by a receiving formation defined in an outer surface of a side wall of a receptacle for the body.

11. (canceled)

12. A drainage device as claimed in claim 1, wherein the body has a thickness in the range of 3 mm to 20 mm.

13. A drainage device as claimed in claim 1, wherein a cross-sectional shape of the body is of a geometric shape selected from the group consisting of: parallelepiped, polygonal, circular, ovular, elliptical, square, rectangular, and triangular.

14. (canceled)

15. A drainage device as claimed in claim 1, wherein walls of the body each have a thickness in the range of 0.4 mm to 2 mm.

16. (canceled)

17. A drainage device as claimed claim 1, wherein the body is manufactured from a plastics material includes at least one of PVC (polyvinylchloride) or ABS (acrylonitrile butadiene styrene).

18. (canceled)

19. (canceled)

20. A drainage device as claimed in claim 1, wherein the body is at least partially received into a receptacle, the receptacle comprising a sanitaryware receptacle.

21. A drainage device as claimed in claim 20, wherein the sanitaryware receptacle is in the form of a receptacle of the group consisting of a bath, basin, and cistern.

22. (canceled)

23. A drainage device as claimed in claim 1, wherein the strengthening means is in the form of a rib formation which is located within and extends along a length of the body.

24. A drainage device as claimed in claim 1, wherein a mounting arrangement is provided for mounting the body to an inner wall of a mould for a receptacle in which the body is at least partially received.

25. A drainage device as claimed in claim 24, wherein the mounting arrangement includes a mounting member including an extension which is sized, shaped and configured to engage with receiving means defined in the inner wall of the mould.

26. A drainage device as claimed in claim 25, wherein the extension is sized, shaped and configured to engage, via interference fit engagement, with the receiving means, the receiving means being in the form of an aperture defined in the inner wall of the mould.

27. (canceled)

28. (canceled)

29. A drainage device as claimed in claim 25, wherein the mounting member includes a connecting formation for connecting the extensions to the body.

30. A drainage device as claimed in claim 25, wherein the mounting arrangement includes a pair of mounting members, including the mounting member, wherein the pair of mounting members is provided for mounting the body, via the opposing end regions, to the inner wall of the mould for ensuring secure mounting of the body on the mould and for inhibiting displacement of the body when moulding material is pumped into the mould.

31. A drainage device as claimed in claim 25, further comprising closure members for closing openings to passage on the opposing end regions of the body during moulding of the receptacle.

32. A drainage device claim 25, further comprising inhibiting formations for inhibiting displacement of the extension into the receiving means beyond a predetermined distance thereby ensuring that the body is substantially centrally positioned relative opposing inner surfaces of the mould or relative opposing outer surfaces of the moulded receptacle before moulding of the receptacle.

33. A drainage device as claimed in claim 25, further comprising locating means comprising protruding members mounted on and extending from the opposing end regions of the body, the protruding members for locating opposing end regions of the body after moulding of the receptacle.

34. (canceled)

35. A drainage device as claimed in claim 33, wherein the protruding members have a length for allowing free end regions thereof to protrude from the moulded receptacle thereby indicating to a worker a location of the opposing end regions of the body.

36-39. (canceled)

40. A method for moulding a sanitaryware receptacle the method comprising:—
mounting a drainage device to an inner surface of a mould for a sanitaryware receptacle, the drainage device being positioned relative the mould such that the end regions of the drainage device coincide with locations of overflow and drainage apertures to be made in the receptacle once moulded;
pumping moulding material into the mould thereby substantially surrounding the drainage device with the moulding material;
allowing the moulding material to harden to form the receptacle;
removing the mould from the moulded receptacle;
locating end regions of the drainage device via the protruding members which are configured to protrude from the receptacle at the locations where the overflow and drainage apertures are to be made;
making a drainage aperture through a base portion of the sanitaryware receptacle, the drainage aperture extending through the base portion and a portion of a first end region of the drainage device; and
making an overflow aperture in the side wall of the receptacle and through a second end region of the drainage device and in doing so, opening a drainage passage defined by the drainage member which extends between the overflow and drainage apertures of the receptacle.

41-45. (canceled)
